(19) United States
(12) Patent Application Publication
(10) Pub. No.: US 2008/0129448 A1
(43) Pub. Date: Jun. 5, 2008

(54) KEY RF FOB

(76) Inventor: ANITA L. REICHLING, New Hampton, IA (US)

Correspondence Address: MCKEE, VOORHEES & SEASE, P.L.C., 801 GRAND AVENUE, SUITE 3200, DES MOINES, IA, 50309-2721, US

(21) Appl. No.: 11/565,689

(22) Filed: Dec. 1, 2006

(51) Int. Cl. G08C 17/02

(52) U.S. Cl. 340/5.72

(57) ABSTRACT

A key radio frequency (RF) fob for remote control of vehicle functions includes a key fob body, a radio-frequency (RF) transmitter disposed within the key fob body and a metal loop extending from the key fob body for fastening the key RF fob to a keyring. The key RF fob may further include a plurality of wedge-shaped buttons such as four wedge-shaped buttons. The key RF fob may include a first cross member and a second cross member wherein the first cross member and the second cross member intersect to form four apertures each of the four wedge-shaped buttons disposed within one of the apertures. Preferably the metal loop extends substantially a length of the bottom side or the width of the key fob body.

### BACKGROUND OF THE INVENTION

The present invention relates to a key RF fob. Such devices are commonly associated with vehicles to provide remote control or keyless entry to vehicles. Despite the widespread use of such devices and numerous examples in the prior art, problems remain.

One problem is related to the use of a key RF fob with specialized vehicles. When a key RF fob is used with vehicles such as recreational vehicles (RVs), specialized vehicles (such as ambulances), conventional key RF fobs may not provide a sufficient number of buttons.

Another problem related to the use of a key RF fob is that sometimes one inadvertently presses a button. This can be a particular problem with seniors. One may, for example, press a button on the key RF fob to lock a door, but then without realizing it, subsequently press a button to unlock the door. Yet another problem with key RF fobs, particular for seniors or others with limited manual dexterity is that such devices may be difficult to hold and operate at the same time without inadvertently pressing a button

Yet another problem related to the use of a key RF fob is that such devices are often difficult to place on a keyring, particularly a keyring which includes a number of keys or other items already present. Sometimes small intermediate rings are used to connect the RF key fob to the keyring. However such small intermediate rings are more likely to fail thereby disconnecting the key RF fob from the keyring. Often times it is difficult to place a key RF fob directly on the keyring. Thus, problems remain with key RF fobs.

### BRIEF SUMMARY OF THE INVENTION

Therefore, it is a primary object, feature, or advantage of the present invention to improve over the state of the art.

It is another object, feature, or advantage of the present invention to provide a key RF fob that easily and conveniently attaches to keyrings.

Yet another object, feature, or advantage of the present invention is to provide a key RF fob that includes relatively large buttons which can be easily depressed by all users, including older users.

A further object, feature, or advantage of the present invention is to provide a key RF fob suitable for use with vehicles such as recreational vehicles or specialty vehicles where the key RF fob may need to control more vehicle functions than needed in an automobile application.

A still further object, feature, or advantage of the present invention is to provide a key RF fob with a visual indicator that one of the buttons has been pressed.

Another object, feature, or advantage of the present invention is to provide a key RF fob designed to avoid accidental pressing of the buttons.

Yet another object, feature, or advantage of the present invention is to provide a key RF fob with ease of assembly features.

A further object, feature, or advantage of the present invention is to provide a key RF fob which may use a lithium battery.

A still further object, feature, or advantage of the present invention is to provide a key RF fob having durable construction.

Another object, feature, or advantage of the present invention is to provide a key RF fob with expanded output by allowing for two buttons to be pressed simultaneously.

Yet another object, feature, or advantage of the present invention is to provide a key RF fob with buttons which provide tactile feedback.

A further object, feature, or advantage of the present invention is to provide a key RF fob with extended battery life.

One or more of these and/or other objects, features, or advantages of the present invention will become apparent from the specification and claims that follow.

According to one aspect of the present invention a key radio frequency (RF) fob for remote control of vehicle functions includes a key fob body, a radio-frequency (RF) transmitter disposed within the key fob body and a metal loop extending from the key fob body for fastening the key RF fob to a key. The key RF fob may further include a plurality of wedge-shaped buttons such as four wedge-shaped buttons. The key RF fob may include a first cross member and a second cross member wherein the first cross member and the second cross member intersect to form four apertures each of the four wedge-shaped buttons disposed within one of the apertures. Preferably the metal loop extends substantially a length of the bottom side or the width of the key fob body.

According to another aspect of the present invention, a key RF fob includes a key fob body having a front side and an opposite rear side, a recessed portion on the front side of the key fob body and a ridge extending around an outer portion of the recessed portion. A pair of cross members intersects to separate the recessed portion into four separate areas, each of the four separate areas corresponding with one of a plurality of buttons for remotely controlling vehicle functions. A radio-frequency (RF) transmitter is disposed within the key fob body for communicating the vehicle functions to a vehicle. There is a metal loop extending from the key fob body.

According to another aspect of the present invention, a key RF fob for control of vehicle functions is provided. The key RF fob includes a key fob body having a front side and an opposite rear side and a recessed portion on the front side of the key fob body. There is a ridge extending above and around an outer portion of the recessed portion. A pair of intersecting cross members separates the recessed portion into four separate areas. There are four wedge shaped buttons for remotely controlling vehicle functions. Each of the four separate areas are formed by the intersecting cross members and each of the four separate areas corresponds with one of the four wedge shaped buttons. A radio-frequency (RF) transmitter is disposed within the key fob body for communicating the vehicle functions to a vehicle. There is a metal loop extending from the key fob body. Preferably, the metal loop extends substantially the width of the key fob body.

### BRIEF DESCRIPTION OF THE DRAWINGS

FIG. 1 is a perspective view of one embodiment of the present invention.

FIG. 2 is a rear view of the embodiment of FIG. 1.

FIG. 3 is a front view of the embodiment of FIG. 1.

FIG. 4 is a side view of the embodiment of FIG. 1.

FIG. 5 is a top end view of the embodiment of FIG. 1.

FIG. 6 is a bottom end view of the embodiment of FIG. 1.

FIG. 7 is an exploded view of one embodiment of the present invention.

FIG. 8 is a block diagram of one embodiment of the present invention in operative communication with a vehicle.

### DETAILED DESCRIPTION OF THE PREFERRED EMBODIMENT

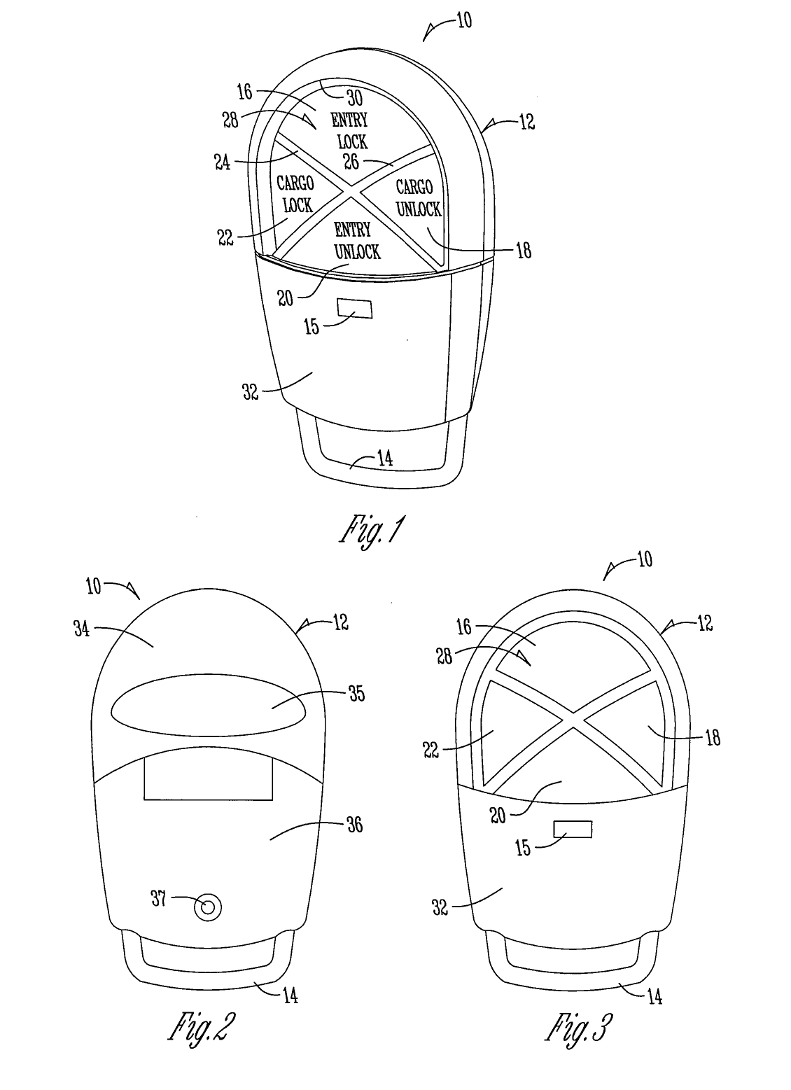

FIG. 1 is a perspective view of one embodiment of the present invention. In FIG. 1, a RF key fob 10 is shown. The RF key fob 10 has an RF key body 12. A metal loop 14 extends downwardly from a bottom end of the RF key body 12 to provide a means for conveniently attaching the RF key fob 10 to a keyring. The width of the loop 14 extends substantially the length of the bottom end of the RF key body 12.

A light 15 such as an LED provides an operator visual feedback when a button is pressed by remaining constantly on or through flashing when one of the buttons 16, 18, 20, 22 is pressed. The LED may be of any number of colors including red, green, yellow, orange, or blue.

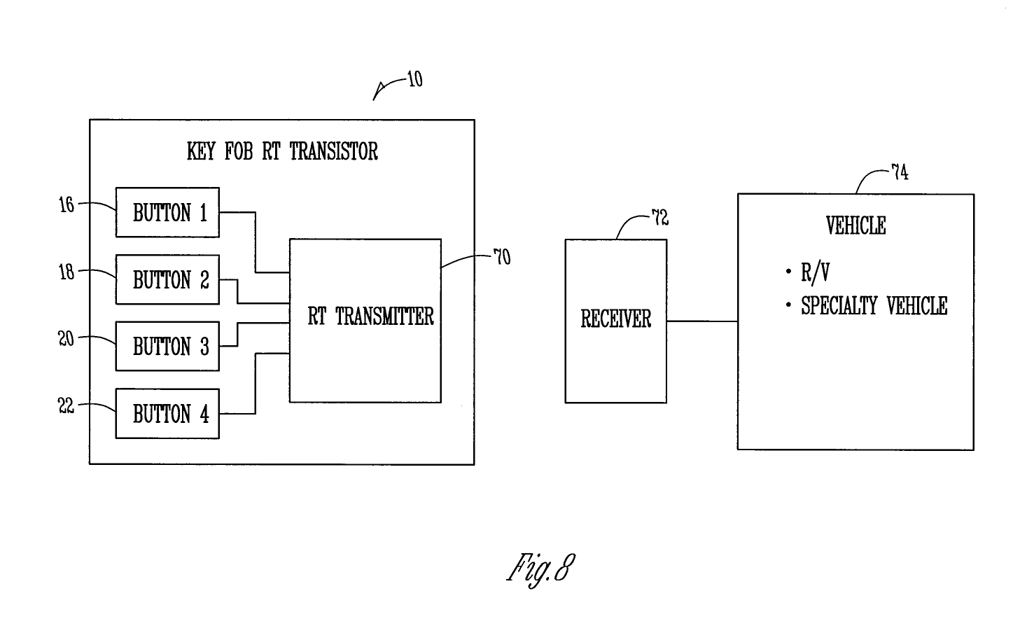

A plurality of large format buttons 16, 18, 20, and 22 are provided on the front side 32 of the body 12. Each of these large format buttons 16, 18, 20, and 22 is of a wedge-shape in order more effectively use available space. Two cross members 24, 26 segment a recess 28 into wedge shapes. In addition each cross member provides sufficient support to assist in making the buttons require a firm press from the user in order to activate. Because the buttons 16, 18, 20, 22 are within the recess in the inset design, a person using the device 10 may rest their thumb on the ridge 30 when holding the device 10 or on the cross members 24, 26 when holding the device. Thus, the device may be conveniently held and the buttons are easy to find and press, yet at the same time the design protects against accidental or inadvertent activation of the buttons. This configuration is believed to be particularly beneficial for older users or users with less manual dexterity. It should also be apparent that different indices may be printed on the buttons 16, 18, 20, and 22. These indices may be words such as shown in FIG. 1 or symbols (see FIG. 7) which correspond to different functions that the device 10 provides.

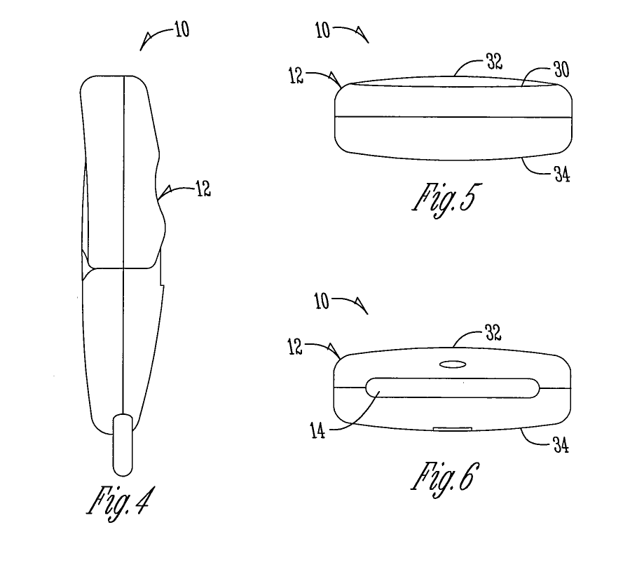

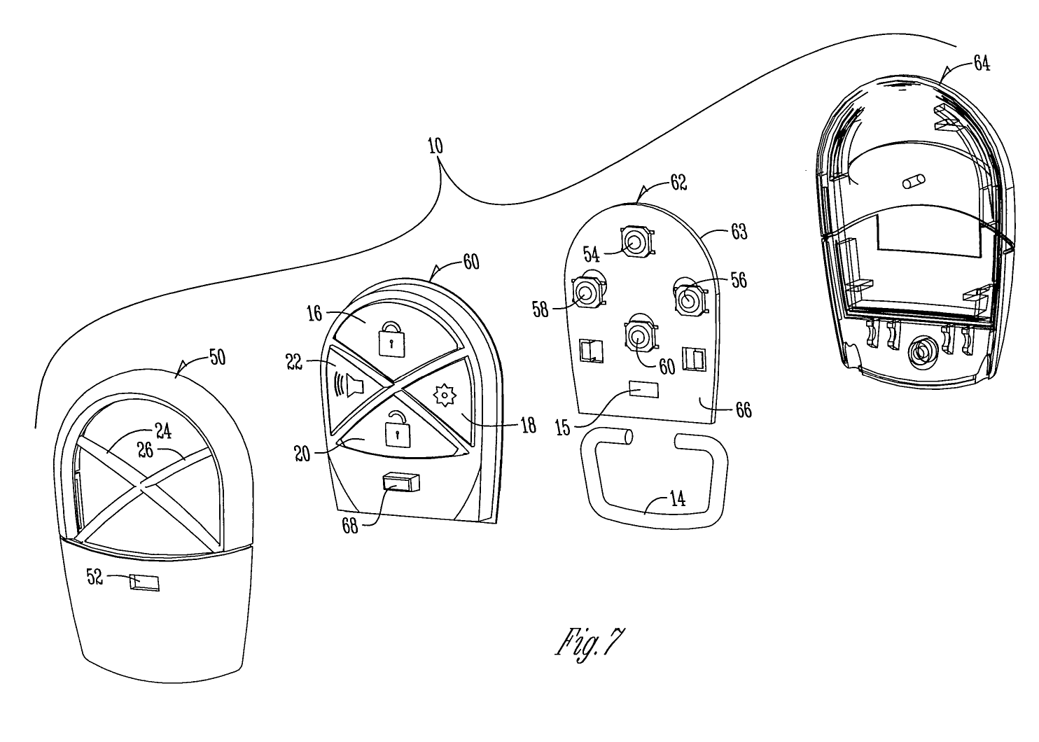

FIG. 2 provides a rear view of the RF key fob 10. In FIG. 2, the rear side 34 of the body 12 is shown. A depression 35 is provided on the rear side 34 of the body 12 which provides a placement for the index finger of a user such that the device 10 may be conveniently held by the user. A rear cover 36 is also provided which is secured with a fastener such as screw 37. Although not shown, it is preferred that a lithium battery be used within the device. A lithium battery provides longer life than a standard alkaline battery. In addition, it is preferred that the battery be of the CR2032 or button cell packaging. This size of battery allows more design flexibility than some of the other sizes which may be used. This size of battery allows a relatively slim profile of the device while also allowing for there to be oversized buttons. FIG. 3-7 provide additional views of the embodiment of the invention shown in FIG. 1 and FIG. 2.

FIG. 7 is an exploded view of one embodiment of the present invention. The RF key fob 10 includes a front cover 50, a back cover 36, a circuit board 62, a metal loop 14 and a elastomer gasket 60. An opening 52 is shown in the front cover 50 corresponding to the location of the LED 15. The elastomer gasket 60 includes buttons 16, 18, 20, 22 which fit into the apertures formed by cross members 24, 26. The elastomer gasket 60 assists in providing a waterproof design. The cross members 24, 26 provide a strong and durable case construction while still allowing for oversized buttons. The circuit board 62 includes momentary switches 54, 56, 58, 60 corresponding to buttons 16, 18, 22, 20 so when one of the buttons is pressed a corresponding electrical connection is made. The device preferably allows for an expanded number of outputs to be used. This is accomplished by allowing for a simultaneous press of two or more buttons to be a separate output. Thus, additional functionality is provided without requiring additional buttons. In addition, the device preferably includes a timeout feature which is activated if a button is pressed for more than a set period of time, such as 30 seconds. The timeout feature may significantly increase battery life. The circuit board 62 includes one or more circuits 63 for accomplishing these functions. The one or more circuits 63 include an RF transmitter.

The placement of the momentary switches 54, 56, 58, 60 under the buttons 16, 18, 22, and 20 provides for an industrial snap action button press which provides tactile feedback to a user for each button press. Tactile feedbacks is another feature which allows for ease of use and convenience.

As shown in FIG. 7, the device is easily assembled which is a significant feature. The various pieces of the device 10 snap or fit together and can be secured with a single screw (see the screw 37 in FIG. 2). Note also that in FIG. 7, each of the buttons displays a symbol corresponding to a vehicle function. Instead of a symbol, words may be used. Of course, the particular symbol or words will vary according to the corresponding vehicle functions. Examples of vehicle functions may include, for example, vehicle lock, vehicle unlock, compartment lock, compartment unlock, as well as any number of other functions.

FIG. 8 is a block diagram illustrating that buttons 16, 18, 20, 22 are electrically connected to an RF transmitter 70. The RF transmitter 70 is in operative communication with receiver 72 associated with a vehicle 74. The vehicle 74 may be of various types include a recreational vehicle, specialty vehicle, or other type of vehicle.

The present invention contemplates numerous variations in the type of RF transmitter used, the number of functions controlled, the specific vehicle functions controlled, the type of vehicle, whether a visual indicator such as an LED is used, the color of such a visual indicator where used, the materials for various structures, the shape of various structures, and other variations. The present invention is not to be limited to the specific embodiments provided herein.

What is claimed is:

1. A key radio frequency (RF) fob for remote control of vehicle functions, comprising:
a key fob body;
a radio-frequency (RF) transmitter disposed within the key fob body;
a metal loop extending from the key fob body for fastening the key RF fob to a keyring.

2. The key RF fob of claim 1 further comprising a plurality of wedge-shaped buttons.

3. The key RF fob of claim 2 wherein the plurality of wedge-shaped buttons includes four wedge-shaped buttons.

4. The key RF fob of claim 3 further comprising a first cross member and a second cross member wherein the first cross member and the second cross member intersect to form four apertures each of the four wedge-shaped buttons disposed within one of the apertures.

5. The key RF fob of claim 1 wherein the key body comprises a front side, a rear side, a top side and a bottom side.

6. The key RF fob of claim 5 wherein the metal loop extends substantially the length of the bottom side.

7. The key RF fob of claim 5 further comprising a depression on the rear side to provide a location for placement of an index finger of a user.

8. The key RF fob of claim 1 further comprising an LED for providing visual feed back to a user of one or more of the buttons being activated.

9. The key RF fob of claim 2 wherein the key RF fob further comprises a ridge with the plurality of wedge-shaped buttons positioned below the ridge to thereby assist in preventing accidental activation of one or more of the wedge-shaped buttons.

10. The key RF fob of claim 9 further comprising momentary switches positioned below each button to provide tactile feedback that a button is pressed.

11. A key RF fob for control of vehicle functions, comprising:
a key fob body having a front side and a rear side;
a recessed portion on the front side of the key body;
a ridge extending around an outer portion of the recessed portion;
a pair of intersecting cross members separating the recessed portion into four separate areas, each of the four separate areas corresponding with one of a plurality of buttons for remotely controlling vehicle functions;
a radio-frequency (RF) transmitter disposed within the key fob body for communicating the vehicle functions to a vehicle; and
a metal loop extending from the key fob body.

12. The key RF fob of claim 11 wherein the width of the metal loop being substantially the same width as the key fob body.

13. The key RF fob of claim 11 further comprising an LED disposed proximate the recessed portion to provide visual feedback that one of the plurality of buttons has been activated.

14. The key RF fob of claim 13 wherein the LED provides red light.

15. The key RF fob of claim 12 wherein a first button within the plurality of buttons provides an entry lock vehicle function, a second button within the plurality of buttons provides an entry unlock vehicle function, a third button within the plurality of buttons provides a cargo lock vehicle function, and the fourth button within the plurality of buttons provides a cargo unlock vehicle function.

16. The key RF fob of claim 11 further comprising an electronic circuit disposed within the body and adapted to determine if more than one of the plurality of buttons is pressed simultaneously to thereby allow for the plurality of buttons to control more functions than one function per button.

17. The key RF fob of claim 16 further comprising an electronic circuit providing for a timeout to occur if one or more buttons is pressed for longer than a predetermined time period.

18. The key RF fob of claim 11 further comprising a depression on the rear side to provide a location for placement of an index finger of a user.

19. A key RF fob for control of vehicle functions, comprising:
a key fob body having a front side and an opposite rear side;
a recessed portion on the front side of the key fob body;
a ridge extending above and around an outer portion of the recessed portion;
a pair of intersecting cross members separating the recessed portion into four separate areas;
four wedge shaped buttons for remotely controlling vehicle functions, each of the four separate areas formed by the intersecting cross members corresponding with one of the four wedge shaped buttons;
a radio-frequency (RF) transmitter disposed within the key fob body for communicating the vehicle functions to a vehicle; and
a metal loop extending from the key fob body.

20. The key RF fob for control of vehicle functions of claim 19 wherein the metal loop extends substantially the width of the key fob body.

21. The key RF fob for control of vehicle functions of claim 19 further comprising an LED disposed proximate the recessed portion to provide visual feedback that one of the four wedge shaped buttons is activated.

22. The key RF fob of claim 19 further comprising an electronic circuit disposed within the body and adapted to determine if more than one of the plurality of buttons is pressed simultaneously to thereby allow for the plurality of buttons to control more functions than one function per button.

23. The key RF fob of claim 19 further comprising an electronic circuit providing for a timeout to occur if one or more buttons is pressed for longer than a predetermined time period.

24. The key RF fob of claim 19 further comprising a depression on the rear side to provide a location for placement of an index finger of a user.

25. The key RF fob of claim 19 further comprising momentary switches positioned below each button to provide tactile feedback that a button is pressed.
